(19) United States
(12) Patent Application Publication
(10) Pub. No.: US 2024/0265926 A1
(43) Pub. Date: Aug. 8, 2024

(54) SYSTEM AND METHOD FOR DETECTING AND CLASSIFYING CLASSES OF BIRDS

(71) Applicant: Loggerhead Instruments Inc., Sarasota, FL (US)

(72) Inventors: David A. Mann, Sarasota, FL (US); Austin T. Anderson, Bradenton, FL (US)

(21) Appl. No.: 18/391,578

(22) Filed: Dec. 20, 2023

Related U.S. Application Data
(60) Provisional application No. 63/483,709, filed on Feb. 7, 2023.

(51) Int. Cl. G10L 17/26; G10L 17/18

(52) U.S. Cl. CPC G10L 17/26; G10L 17/18

(57) ABSTRACT

A hybrid edge and cloud system for detecting and identifying bird vocalizations including an edge device having an edge neural network. The edge neural network is trained with audio samples for making predictions about identification of the bird vocalizations. The system includes an audio sensor connected to the edge neural network for sending sound information to the edge neural network. The system includes a cloud computing system having a cloud neural network for processing the sound information, a first storage service, a second storage service, and a hit table which stores metadata about sound detections. The edge neural network generates a score for each of the trained audio samples based on predictions made from a sound audio clip and selects a top scoring audio sample. The hybrid edge and cloud system includes a browsing device having access to the cloud computing system and may request information from the hit table.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims the benefit of U.S. Provisional Patent Application No. 63/483,709, filed on Feb. 7, 2023, which is incorporated by reference herein in its entirety.

### BACKGROUND OF THE INVENTION

### 1) Field of the Invention

The instant invention relates to the field of bird and other sound detection and classification systems and methods for pattern recognition using electronic means.

### 2) Description of Related Art

Currently the state of the art includes amateur birdwatchers who attempt to identify birds using their songs and calls, often called “birding by ear.” This is much like learning a new language and can be a challenge for many. Further, the identification of birds using their vocalizations may require a person to be actively birding such as, being outside and/or actively hearing a bird. Automatic and continuous acoustic monitoring has not been possible.

### BRIEF SUMMARY OF THE INVENTION

The instant invention in one form is directed to a system and method for efficiently detecting and classifying large numbers of classes of birds with a long-tail distribution. With the instant invention installed at their home, for example, a consumer can see the identified species, hear their vocalizations through short recordings, and see a wealth of data about when the birds are vocalizing, allowing inferences about their nesting and migration patterns. An added benefit is that these ornithological and environmental data can be shared with scientific researchers who can analyze and make discoveries with them.

Internet of Things (IoT) systems consist of edge devices which are connected to remote cloud servers to which they transmit data of interest. In consumer products, edge devices are equipped with sensors and placed in the consumer's home so they can detect a signal of interest (e.g., sounds, vibrations, movement, images). An edge device (e.g., smart speaker) is always ready to detect a signal of interest (e.g., the wake-up word “Alexa”). These devices work because they run internal calculations, called signal processing algorithms. When the algorithm identifies a correct match, the edge device sends the detection information to a cloud system which then alerts or provides information to the consumer. In a smart speaker scenario, a consumer says “Alexa, what time is it in London?” The edge device senses the wake-word, sends the information to a cloud system, which returns the response to the consumer: “It's 8:00 in London.”

Neural networks, or neural nets, are a form of artificial intelligence or machine learning which is trained to take input data and make predictions. For example, a neural net is behind the smart speaker's ability to understand human language regardless of an individual's accent or tone. Neural nets are often used when there are many signals of interest (i.e., classes of signal) such as in language where there are hundreds or thousands of signals to be classified. Neural nets tend to improve in accuracy the larger they are, meaning there are more classes and variations that can be identified. However, edge devices are often constrained in the amount of memory accessible, computational capabilities available, and/or battery power, thus making it challenging to run very large neural nets on edge devices. In these cases, one solution may be to transmit all of the signals (e.g., audio or image) to a cloud system capable of running a neural net large enough to classify all of the signals of interest. This design is not feasible in many situations including: a cost-constrained consumer product which requires minimizing cloud computing costs, a connected network in which there are many edge devices, or a device that has limited bandwidth to communicate with the cloud servers.

Using a unique combination of hardware, edge and cloud computing, user input and neural net development, the instant invention will allow users to learn more about the birds visiting their homes, through an automated and continuous passive acoustic monitoring system.

One object of the present invention is classification or organizing sound patterns into predefined classes.

Another object of the present invention is the identification of a unique aspect of each sound pattern instance to classify it even without any other context present.

Another object of the present invention is prediction, or the production of expected results using a relevant input, even when all context is not provided.

The above and other objects, which will be apparent to those skilled in the art, are achieved in the present invention which is directed to a hybrid edge and cloud system for detecting and identifying bird vocalizations. The hybrid edge and cloud system includes an edge device. The edge device includes an edge neural network running on the edge device, the edge neural network trained with audio samples for making predictions about identification of the bird vocalizations, the edge neural network for generating a score based on the predictions. The edge device includes an audio sensor connected to the edge neural network, the audio sensor for sending sound information to the edge neural network, The hybrid edge and cloud system for detecting and identifying bird vocalizations includes a peripheral neural network with a cloud computing system that includes a cloud neural network for processing the sound information. The peripheral neural network includes a first storage service, a second storage service in the peripheral neural network and a hit table which stores metadata about bird detections. The edge neural network that has been trained on bird and other audio clips processes recorded audio clips and selects a top scoring audio sample. If the top scoring audio sample is not on a list of common bird species, the edge device sends the bird audio clip as a raw detection to the second storage service whereby the bird clip is processed for cloud inference and sent to the hit table. If the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table. The system includes a browsing device for browsing and listening, the browsing device having access to the peripheral network. The browsing device may request and receive video and audio information from the hit table regarding at least one of plurality of birds for which the hit table includes. The browsing device may request and receive the video and the audio information after processing from the first storage service. The edge device may be a portable device.

Another aspect of the present invention is directed to a method for using hybrid processing that includes providing an edge device including an edge neural network running on the edge device, the edge neural network trained with audio samples for making predictions about identification of the bird vocalizations, the edge neural network for generating a score based on the predictions and an audio sensor connected to the edge for sending sound information to the edge neural network. The method includes providing access to a peripheral neural network with a cloud computing system that includes a cloud neural network for processing the sound information, the peripheral neural network including a first storage service and a second storage service in the peripheral neural network and a hit table which stores metadata about bird detections. The method includes providing a browsing device for browsing and listening, the browsing device having access to the peripheral network. The method includes the edge neural network generating a score for each of the trained audio samples based on predictions made from a bird audio clip and selecting a top scoring audio sample. If the top scoring audio sample is not on a list of common bird species, the edge device sends the bird audio clip as a raw detection to the second storage service whereby the bird clip is processed for cloud inference and sent to the hit table. If the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table. The method includes the browsing device requesting and receiving video and audio information from the hit table regarding at least one of plurality of birds for which the hit table includes. The method includes the browsing device requesting and receiving the video and the audio information after processing from the first storage service.

Another aspect of the present invention is directed to a hybrid edge and cloud system for detecting and identifying bird vocalizations. The hybrid edge and cloud system includes an edge device including an audio sensor for audio input on an edge neural network trained with audio samples for making predictions about identification of the bird vocalizations. The edge device communicates with a cloud neural network for processing the sound information, the cloud neural network including a hit table which stores metadata about bird detections. The edge neural network generates a score for each of the trained audio samples based on predictions made from a bird audio clip and selects a top scoring trained audio sample. If the scores indicate that no trained audio sample matches the bird audio clip, the bird audio clip is sent to the cloud neural network wherein the bird audio clip is processed for cloud inference and sent to the hit table. If the top scoring audio sample is on a list of common bird species, the edge device may determine that if the bird clip is not a published bird clip, the bird clip is sent to the hit table and if the bird clip is a published bird clip, the bird clip is sent to the first storage drive wherein the bird clip is processed for entry into the hit table. The system may include a browsing device for browsing and listening, the browsing device having access to the cloud neural network wherein the browsing device may request and receive video and audio information from the hit table regarding at least one of plurality of birds for which the hit table includes and wherein the browsing device may request and receive the video and the audio information after processing from the first storage drive. The edge neural network may generate a score based on the predictions, and a score is provided for each trained audio sample based on the predictions and the highest scoring trained audio sample is determined. The first storage drive may be a first storage service and the second storage drive may be a second storage service in the cloud neural network. The edge neural network may generate a score for each of the trained audio samples based on predictions made from the bird audio clip and selects a top scoring audio sample and if the top scoring audio sample is not on a list of common bird species, the edge device sends the bird audio clip as a raw detection to the second storage drive whereby the bird clip is processed for cloud inference and sent to the hit table. The edge neural network may generate a score for each of the trained audio samples based on predictions made from the bird audio clip and selects a top scoring audio sample and if the top scoring audio sample is on a list of common bird species, the edge device determines that if the bird clip is a not published bird clip, the bird clip is sent to the hit table and if the bird clip is a published bird clip, the bird clip is sent to the first storage drive wherein the bird clip is processed for entry into the hit table.

Another aspect of the present invention is directed to a hybrid edge and cloud system for detecting and identifying a sound. The hybrid edge and cloud system includes an edge device having an edge neural network running on the edge device. The edge neural network is trained with audio samples for making predictions about identification of the sound. The edge neural network generates a score based on the predictions. The edge device includes an audio sensor connected to the edge neural network, the audio sensor for sending sound information to the edge neural network. The system includes a peripheral neural network with a cloud computing system that includes a cloud neural network for processing the sound information. The peripheral neural network includes a first storage service, a second storage service and a hit table which stores metadata about sound detections. The edge neural network generates a score for each ofthe trained audio samples based on predictions made from a sound audio clip and selects a top scoring audio sample. If the top scoring audio sample is not on a list of common sounds, the edge device sends the sound audio clip as a raw detection to the second storage service whereby the sound clip is processed for cloud inference and sent to the hit table. If the top scoring audio sample is on a list of common sounds, the edge device determines that if the sound clip is not a published sound clip, the sound clip is sent to the hit table and if the sound clip is a published sound clip, the sound clip is sent to the first storage service wherein the sound clip is processed for entry into the hit table. The system includes a browsing device for browsing and listening, the browsing device having access to the peripheral network. The browsing device may request and receive video and audio information from the hit table regarding at least one of plurality of sounds for which the hit table includes. The browsing device may request and receive the video and the audio information after processing from the first storage drive.

Another aspect of the present invention is directed to a hybrid edge and cloud system for detecting and identifying bird vocalizations, the hybrid edge and cloud system including an edge device having an edge neural network running on the edge device. The edge neural network is trained with audio samples for making predictions about identification of the bird vocalizations. The edge neural network is for generating a score based on the predictions. The system includes an audio sensor connected to the edge neural network. The audio sensor is for sending sound information to the edge neural network. The hybrid edge and cloud system includes a cloud computing system having a cloud neural network for processing the sound information. The cloud computing system includes a first storage service, a second storage service, and a hit table which stores metadata about sound detections. The edge neural network generates a score for each of the trained audio samples based on predictions made from a sound audio clip and selects a top scoring audio sample. If the top scoring audio sample is not on a list of common sounds, the edge device sends the sound audio clip as a raw detection to the second storage service whereby the sound clip is processed for cloud inference and sent to the hit table. If the top scoring audio sample is on a list of common sounds, the edge device determines that if the sound clip is not a published sound clip, the sound clip is sent to the hit table and if the sound clip is a published sound clip, the sound clip is sent to the first storage service wherein the sound clip is processed for entry into the hit table. The hybrid edge and cloud system includes a browsing device for browsing and listening, the browsing device having access to the cloud computing system whereby the browsing device may request and receive video and audio information from the hit table regarding at least one of a plurality of sounds for which the hit table includes. The browsing device may request and receive the video and the audio information after processing from the first storage service.

In some aspects, the techniques described herein relate to a computer program including instructions which, when the program is executed by a computer, cause the computer to carry out the steps including: detecting, using a detector, a sound; identifying, using an edge neural network or a cloud neural network, a bird species from the detected sound; storing, using a database, the detected sound of the identified bird species; and displaying, using a device, the identified bird species to a user.

### BRIEF DESCRIPTION OF THE DRAWINGS

These and other objects, features, and advantages of the present invention will become more readily apparent from the attached drawings and the detailed description of the preferred embodiments, which follow.

FIGS. 1A-1, 1A-2 and 1B are a graph showing bird detection data collected by one embodiment of the present invention;

FIG. 2 is a flow chart of the listening system;

FIG. 3 is a block diagram showing the hybrid edge and cloud system according to the present invention;

FIGS. 4A and 4B are a graph showing bird detection data collected by a standalone listening system;

FIG. 5 is a graph showing bird detection data identified by the instant invention;

FIGS. 6A-1, 6A-2 and 6B are a graph showing bird detection data identified by the instant invention;

FIG. 7 is a flow chart of the listening system;

FIG. 8 is a diagram showing a system for detecting and classifying classes of birds; and

FIG. 9 is a block diagram showing one embodiment of the hybrid edge and cloud system according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

In a hybrid ‘serial’ or ‘chained’ neural network according to the present invention, there are two neural nets; one on edge device and one on a cloud device. The one on cloud device costs more resources (power, money, data etc.) so any determination should first be attempted by the edge neural network. If that is unable to classify a sound or is unable to classify a sound to a particular certainty, then that sound clip is forwarded to the cloud server neural net to apply the more powerful neural network.

The instant invention hybrid ‘serial’ or ‘chained’ edge and cloud networks allows the system to apply the computing power to the sound pattern recognition efficiently by allowing an edge device to provide identifications for many common birds and preserves the higher resource cloud neural network to handle requests for identification unable to be handled by an edge device. Furthermore, it allows the machine learning algorithms to be changed as it learns from their training and subsequent operations.

A neural network is a software solution that leverages machine learning (ML) algorithms to ‘mimic’ the operations of a human brain. Neural networks feature improved pattern recognition and problem-solving capabilities when compared to traditional signal processing on a computer. Neural networks are also known as artificial neural networks (ANNs) and simulated neural networks (SNNs).

The architecture of the instant invention is a convolutional neural network (CNN). The Convolutional Neural Network (CNN) is a deep learning architecture that is suited for extracting features from data with spatial and/or temporal relationships. CNNs have a hierarchical structure composed of a series of convolutional layers that highlight task-relevant features and pooling layers that reduce dimensionality. Other neural network architectures may be used on the edge device and/or cloud server.

The instant invention of neural networks classifies data at high speeds. This means that it can complete the recognition of sounds rapidly instead of the hours that it would take when carried out by human experts.

Associating or training enables instant invention neural networks to encode sound patterns. If the computer is shown an unfamiliar sound pattern, it will associate the sound pattern with the closest match present in its memory.

The instant invention neural networking process begins with the first tier receiving the raw input sound pattern. After that, each consecutive tier gets the results regarding the sound pattern from the preceding one. This goes on until the final tier has processed the sound pattern and produced the output.

The learning process (also known as training) begins once a neural network is structured for a specific application. Training can take either a supervised approach or an unsupervised approach. In the former, the network is provided with correct outputs either through the delivery of the desired input and output combination or the manual assessment of network performance. Unsupervised training occurs when the network interprets inputs and generates results without external instruction or support.

Adaptability of the instant invention is one of the essential qualities of the instant invention neural network. This network has a local network that lives on the edge device and a cloud network that lives on the cloud. If the local network cannot determine the sound pattern origin, then the edge device transfers the sound pattern to the cloud network for processing. This allows the system to respond to a sound pattern immediately, because if it can be solved locally, the instant invention provides the result quickly and if it cannot be solved on the local network, the cloud network can identify the sound pattern.

The instant invention is enabled such that when the neural network processes a sound clip, it outputs confidence levels for each class, which includes ‘bird’, ‘blue jay’, ‘siren’. Those outputs come all at once. The algorithm in the device looks at whether a bird is present, if so, it then looks if it is one of the common species and what that confidence score is to determine if it can be sent as a direct detection, or if it needs to be sent to the cloud neural network.

The instant invention is a hybrid ‘serial’ or ‘chained’ edge and cloud neural network which allows the system to apply the computing power to the sound pattern recognition and allows the machine learning algorithms to be changed as it learns from their training and subsequent operations.

As this invention is susceptible to embodiments of many different forms, it is intended that the present disclosure be considered as an example of the principles of the invention and not intended to limit the invention to the specific embodiments shown and described.

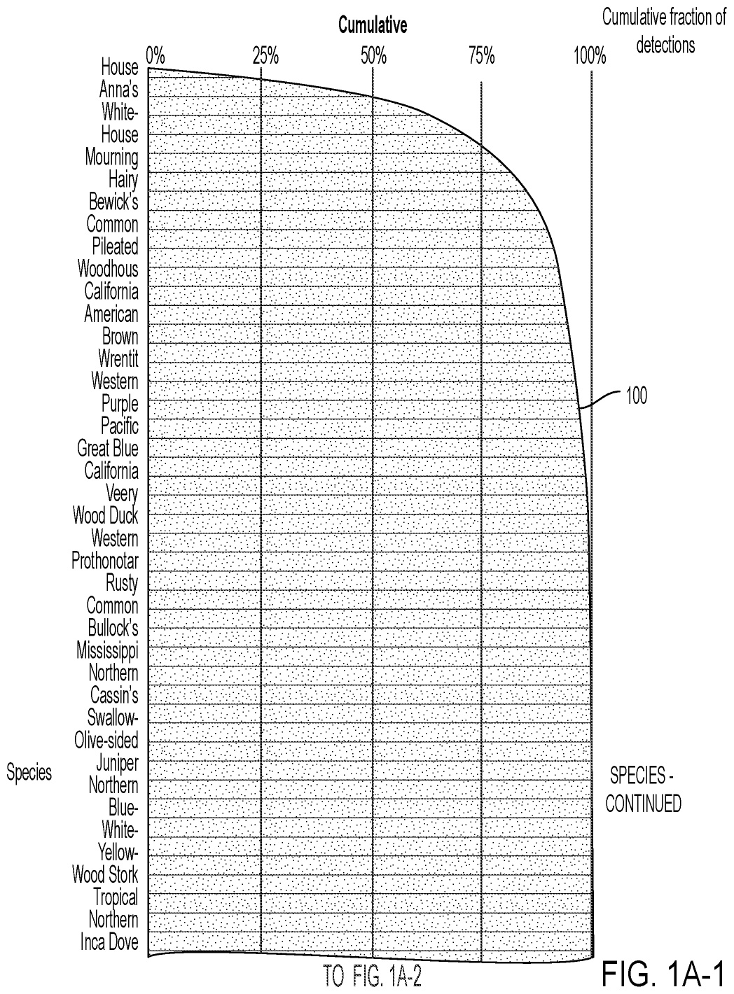

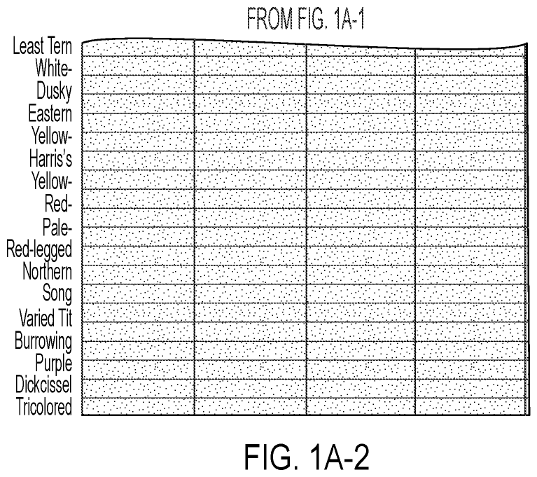

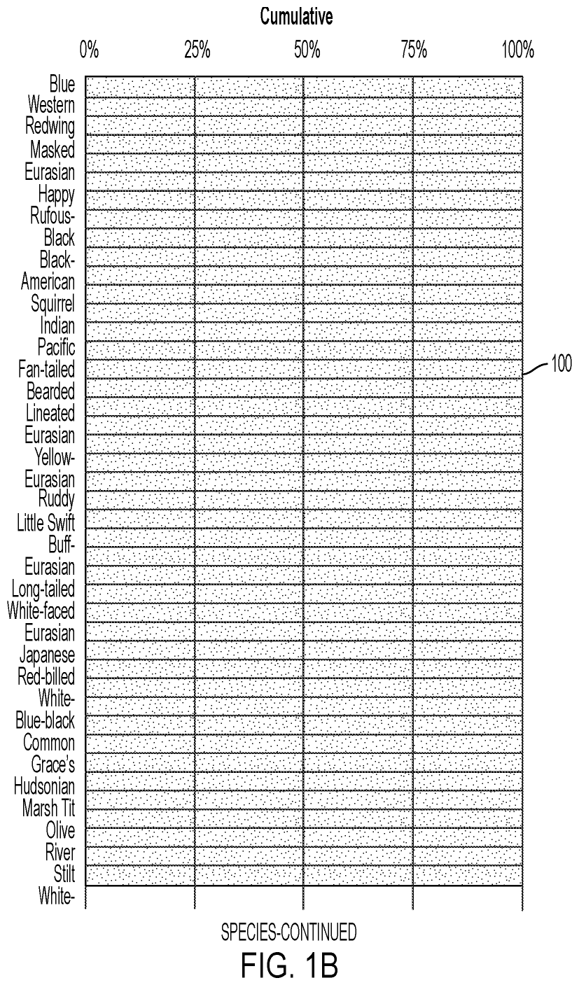

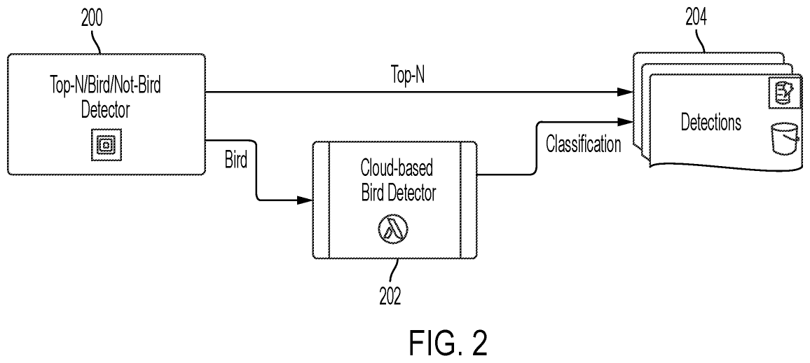

FIGS. 1A-1, 1A-2 and 1B are a graph showing bird detection data collected by the instant invention. At 100, the cumulative percentage of all bird detections is plotted on the y-axis, with bird species ranked by how frequently that species was detected on the x-axis. This graph shows that a relatively small fraction of species are responsible for the majority of detections by the present invention. Therefore, a hybrid edge device and cloud computing neural network will be favorable to use in this particular embodiment. In particular, the edge device neural network may be utilized for identifying a large portion of the total audio clips to be analyzed, because the vast majority of detections are accounted for by only a small group bird species. Where the edge device neural network may have trouble identifying a unique or otherwise rare bird sound, that audio clip may be sent to a cloud based neural network to be analyzed in more depth. Splitting the workload between the edge device neural network and the cloud neural network for a task such as this can lead to improvements to identification accuracy and overall system performance.

FIG. 2 is a flow chart of one embodiment of the instant invention. This system uses a combination of edge and cloud computing to identify species of birds by their audio vocalizations. At 200, sounds are first detected and run through a neural net algorithm by the “Top-N/Bird/Not-Bird Detector.” Bird/Not-Bird Detector refers to the neural network making a determination whether the analyzed audio clip contains a bird sound or not. Top-N refers to the number of classes included in the neural net, for example the most common 60 bird species would be the “Top-60.” At 204, if the sound is identified by the edge neural network, the identification is stored directly to a database and skips the cloud-based bird detector. At 202, however, those sounds not identifiable by the edge neural network will be communicated to the cloud-based neural net for further processing in order to get a more accurate certainty score from a larger set of potential classes. The audio clips sent to the cloud neural network may similarly be stored in the detection database.

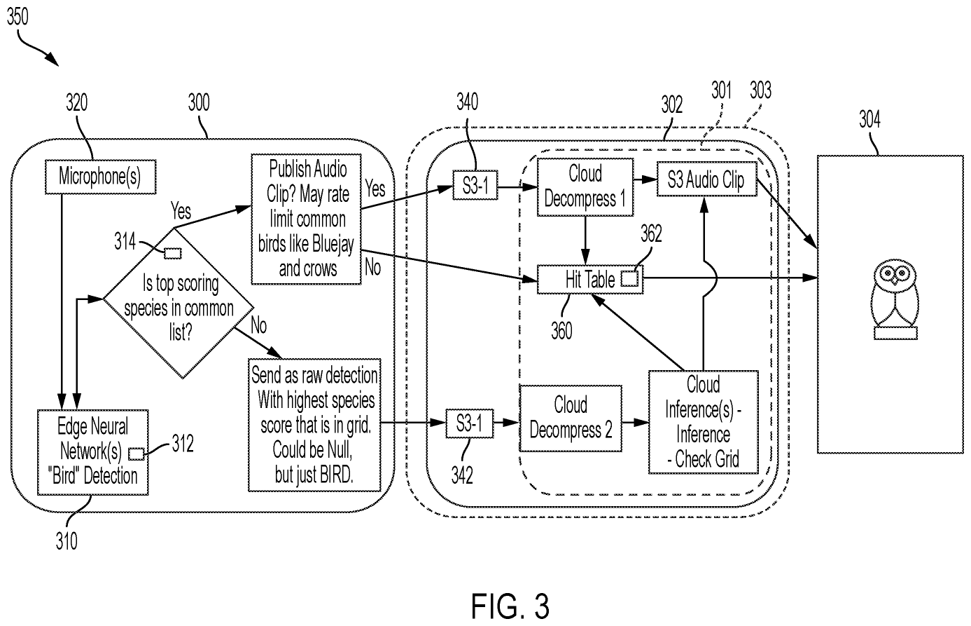

FIG. 3 is a block diagram showing another embodiment of the hybrid edge and cloud system 350. The system 350 is for detecting and identifying bird vocalizations. The hybrid edge and cloud system 350 includes an edge device 300. The edge device 300 includes an edge neural network 310 running on the edge device 300, the edge neural network 310 trained with audio samples 312 for making predictions about identification of the bird vocalizations, the edge neural network 310 for generating a score 314 based on the predictions. The edge device 300 includes an audio sensor 320 connected to the edge neural network 310, the audio sensor 320 for sending sound information to the edge neural network 310. The hybrid edge and cloud system 350 for detecting and identifying bird vocalizations includes a peripheral neural network 303 with a cloud computing system 301 that includes a cloud neural network 302 for processing the sound information. The peripheral neural network 303 includes a first storage service 340 and a second storage service 342 in the peripheral neural network 303. The peripheral neural network 303 includes a hit table 360 which stores metadata 362 about bird detections. The edge neural network 310 generates a score 314 for each of the trained audio samples 312 based on predictions made from a bird audio clip and selects a top scoring audio sample. If the top scoring audio sample is not on a list of common bird species, the edge device 300 sends the bird audio clip as a raw detection to the second storage service whereby the bird clip is processed for cloud inference and sent to the hit table. If the top scoring audio sample is on a list of common bird species, the edge device 300 determines that if the bird clip is not a published bird clip, the bird clip is sent to the hit table and if the bird clip is a published bird clip, the bird clip is sent to the first storage service wherein the bird clip is processed for entry into the hit table. The system includes a browsing device 304 for browsing and listening, the browsing device 304 having access to the peripheral network. The browsing device 304 may request and receive video and audio information from the hit table regarding at least one of plurality of birds for which the hit table includes. The browsing device 304 may request and receive the video and the audio information after processing from the first storage service. The edge device 300 may be a portable device.

Another aspect of the present invention as shown in FIG. 3 is directed to a method for using the system 350 for detecting and identifying bird vocalizations. The method includes providing access to a peripheral neural network 303 with a cloud computing system that includes a cloud neural network for processing the sound information, the peripheral neural network 303 including a first storage service and a second storage service in the peripheral neural network 303 and a hit table which stores metadata about bird detections. The method includes providing a browsing device 304 for browsing and listening, the browsing device 304 having access to the peripheral network. The method includes the edge neural network 310 generating a score for each of the trained audio samples based on predictions made from a bird audio clip and selecting a top scoring audio sample. If the top scoring audio sample is not on a list of common bird species, the edge device 300 sends the bird audio clip as a raw detection to the second storage service whereby the bird clip is processed for cloud inference and sent to the hit table. If the top scoring audio sample is on a list of common bird species, the edge device 300 determines that if the bird clip is not a published bird clip, the bird clip is sent to the hit table and if the bird clip is a published bird clip, the bird clip is sent to the first storage service wherein the bird clip is processed for entry into the hit table. The method includes the browsing device 304 requesting and receiving video and audio information from the hit table regarding at least one of plurality of birds for which the hit table includes. The method includes the browsing device 304 requesting and receiving the video and the audio information after processing from the first storage service.

Another aspect of the present invention as shown in FIG. 3 is directed to a hybrid edge and cloud system for detecting and identifying bird vocalizations. The hybrid edge and cloud system includes an edge device 310 including an audio sensor 320 for audio input on an edge neural network 310 trained with audio samples for making predictions about identification of the bird vocalizations. The edge device 300 communicates with a cloud neural network for processing the sound information, the cloud neural network including a hit table which stores metadata about bird detections. The edge neural network 310 generates a score for each of the trained audio samples based on predictions made from a bird audio clip and selects a top scoring trained audio sample. If the scores indicate that no trained audio sample matches the bird audio clip, the bird audio clip is sent to the cloud neural network wherein the bird audio clip is processed for cloud inference and sent to the hit table. If the top scoring audio sample is on a list of common bird species, the edge device 300 may determine that if the bird clip is not a published bird clip, the bird clip is sent to the hit table and if the bird clip is a published bird clip, the bird clip is sent to the first storage service wherein the bird clip is processed for entry into the hit table. The system may include a browsing device 304 for browsing and listening, the browsing device 304 having access to the cloud neural network wherein the browsing device 304 may request and receive video and audio information from the hit table regarding at least one of plurality of birds for which the hit table includes and wherein the browsing device 304 may request and receive the video and the audio information after processing from the first storage service. The edge neural network 310 may generate a score based on the predictions, and a score is provided for each trained audio sample based on the predictions and the highest scoring trained audio sample is determined. The first storage service may be a first storage service and the second storage service may be a second storage service in the cloud neural network. The edge neural network 310 may generate a score for each of the trained audio samples based on predictions made from the bird audio clip and selects a top scoring audio sample and if the top scoring audio sample is not on a list of common bird species, the edge device 300 sends the bird audio clip as a raw detection to the second storage service whereby the bird clip is processed for cloud inference and sent to the hit table. The edge neural network 310 may generate a score for each of the trained audio samples based on predictions made from the bird audio clip and selects a top scoring audio sample and if the top scoring audio sample is on a list of common bird species, the edge device 300 determines that if the bird clip is not a published bird clip, the bird clip is sent to the hit table and if the bird clip is a published bird clip, the bird clip is sent to the first storage service wherein the bird clip is processed for entry into the hit table.

Another aspect of the present invention is directed to a hybrid edge and cloud system for detecting and identifying a sound. The hybrid edge and cloud system includes an edge device 300 having an edge neural network 310 running on the edge device. The edge neural network 310 is trained with audio samples for making predictions about identification of the sound. The edge neural network 310 generates a score based on the predictions. The edge device includes an audio sensor 320 connected to the edge neural network 310, the audio sensor 320 for sending sound information to the edge neural network 310. The system includes a peripheral neural network 303 with a cloud computing system that includes a cloud neural network for processing the sound information. The peripheral neural network 303 includes a first storage service, a second storage service and a hit table which stores metadata about sound detections. The edge neural network 310 generates a score for each of the trained audio samples based on predictions made from a sound audio clip and selects a top scoring audio sample. If the top scoring audio sample is not on a list of common sounds, the edge device 300 sends the sound audio clip as a raw detection to the second storage service whereby the sound clip is processed for cloud inference and sent to the hit table. If the top scoring audio sample is on a list of common sounds, the edge device 300 determines that if the sound clip is not a published sound clip, the sound clip is sent to the hit table and if the sound clip is a published sound clip, the sound clip is sent to the first storage service wherein the sound clip is processed for entry into the hit table. The system includes a browsing device 304 for browsing and listening, the browsing device 304 having access to the peripheral network. The browsing device 304 may request and receive video and audio information from the hit table regarding at least one of plurality of sounds for which the hit table includes. The browsing device 304 may request and receive the video and the audio information after processing from the first storage service.

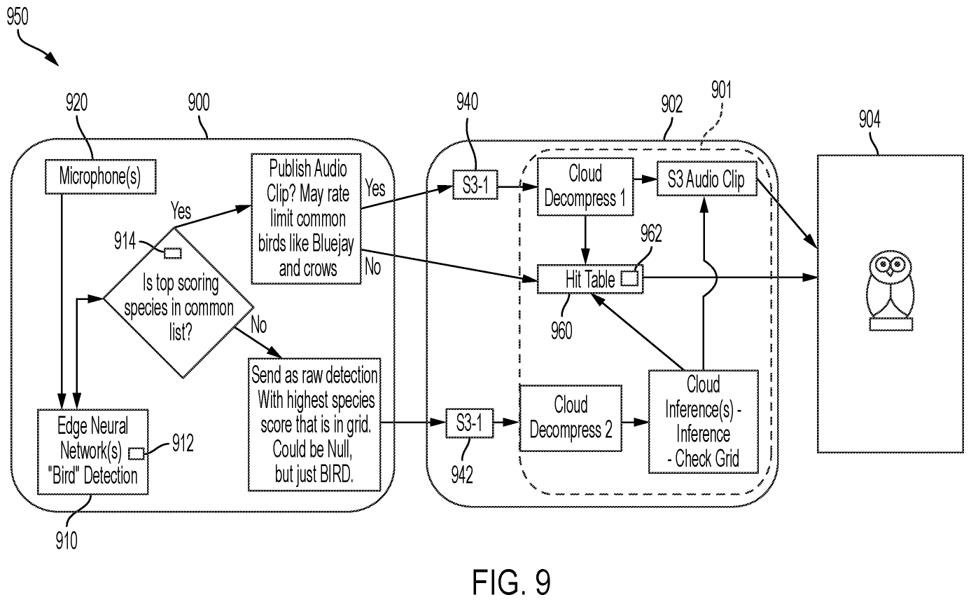

In another aspect of the present invention, a hybrid edge and cloud system 950 for detecting and identifying bird vocalizations as shown in FIG. 9. The hybrid edge and cloud system 950 includes an edge device 900 having an edge neural network 910 running on the edge device 900. The edge neural network 910 is trained with audio samples 912 for making predictions about identification of the bird vocalizations. The edge neural network 910 is for generating a score based on the predictions. The system 950 includes a microphone or other audio sensor 920 connected to the edge neural network 910. The audio sensor 920 is for sending sound information to the edge neural network 910. The hybrid edge and cloud system 950 includes a cloud computing system 902 having a cloud neural network 901 for processing the sound information. The cloud computing system 902 includes a first storage service 940, a second storage service 942, and a hit table 960 which stores metadata 962 about sound detections. The edge neural network 910 generates a score for each of the trained audio samples based on predictions made from a sound audio clip and selects a top scoring audio sample 914. If the top scoring audio sample 914 is not on a list of common sounds, the edge device 900 sends the sound audio clip as a raw detection to the second storage service 942 whereby the sound clip is processed for cloud inference and sent to the hit table. If the top scoring audio sample 914 is on a list of common sounds, the edge device 900 determines that if the sound clip is not a published sound clip, the sound clip is sent to the hit table 960 and if the sound clip is a published sound clip, the sound clip is sent to the first storage service wherein the sound clip is processed for entry into the hit table. The hybrid edge and cloud system 950 includes a browsing device 904 for browsing and listening, the browsing device 904 having access to the cloud computing system whereby the browsing device 904 may request and receive video and audio information from the hit table regarding at least one of a plurality of sounds for which the hit table 960 includes. The browsing device 904 may request and receive the video and the audio information after processing from the first storage service 940.

It is within the scope of this invention for S3=Amazon Web Services (AWS) Simple Storage Service including, but is not limited to, a server hard drive or other similar device. Moreover, it is within the scope of this invention for a hit table that is represented in an Amazon Web Services DynamoDB database table configured for storing metadata about bird detections. At 304, an end user device, such as a cellular phone, includes a display screen and is configured to display a photograph and other associated information of a bird detected by the system. As may be understood by one skilled in the art, the present embodiment of the listening program is specifically designed for bird vocalization detection, identification, and real-time presentation to customers on the display of an electronic device. However, the hybrid neural network system as a whole may be used to identify any number of things other than bird vocalizations using various input signals (e.g., audio, video, radio frequency) and appropriately trained neural networks.

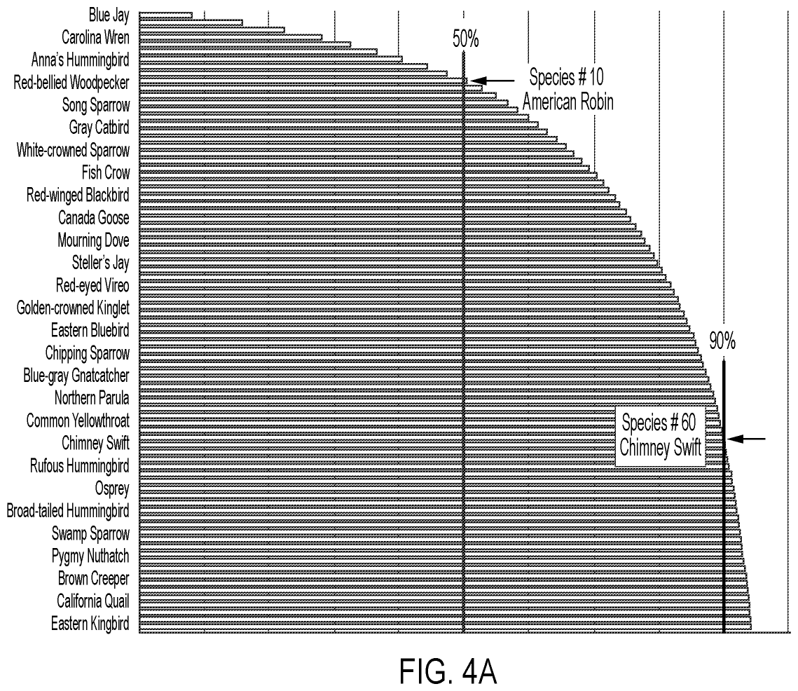

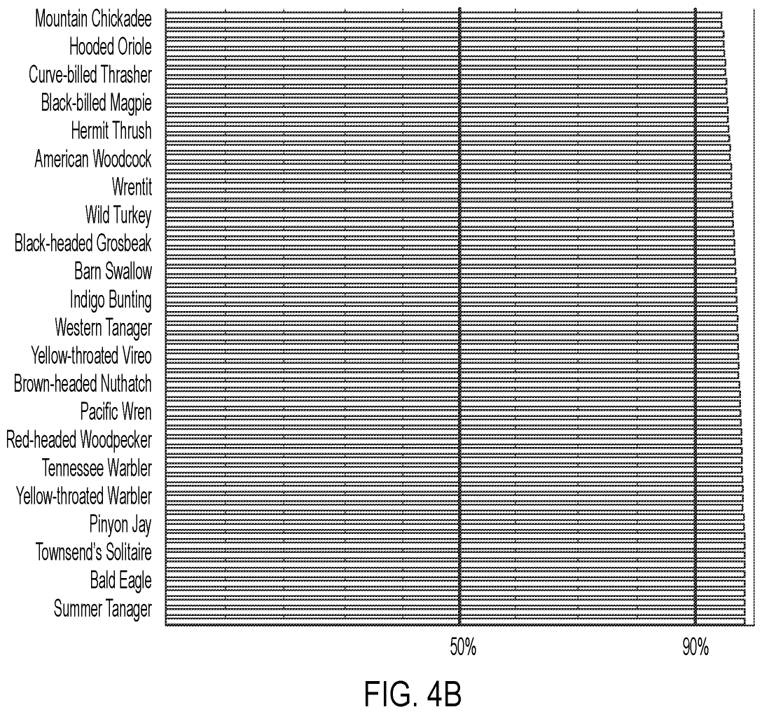

FIGS. 4A and 4B are illustrations of a graph showing bird detection data collected by the preferred embodiment of the instant invention. At 400, the cumulative percentage of the top one hundred and fifty bird species detections, with bird species ranked by how common they are, may be displayed. A relatively small fraction of species are responsible for the majority of detections. It is within the scope of this invention for only a select number of species to be displayed. However, it will be understood that the system is capable of detecting and displaying any amount of bird species.

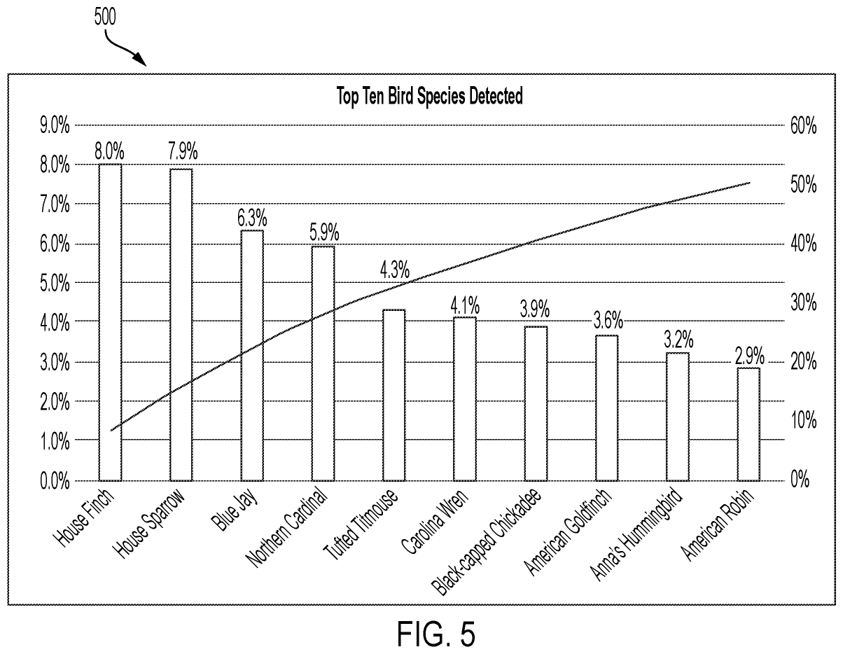

FIG. 5 is an illustration of a graph showing a more detailed look at the top ten bird species identified by a preferred embodiment of the present invention. At 500, each bar shows that species' percentage of the total number of detections. For example, over 3 million House Finch detections made up 8.0% of the 38 million total detections, which made the House Finch the most commonly identified species. The line shows the cumulative percentage of the bird detections. These ten species made up over 50% of all bird detections.

Because so few of the most commonly identified species account for a large portion of the total detections, the edge neural network portion of the present hybrid system may be configured to run on a smaller and less complex neural network for most detections improving the speed of any detection overall while simultaneously providing a sufficiently more complex alternative cloud neural network to handle the far fewer number of less common bird species. Splitting the workload in this fashion results in improvements in overall system speed and accuracy. Very common birds can be identified quickly at the edge device neural network while simultaneously providing an alternative cloud neural network with increased computational costs available as needed when more complex identifications are required.

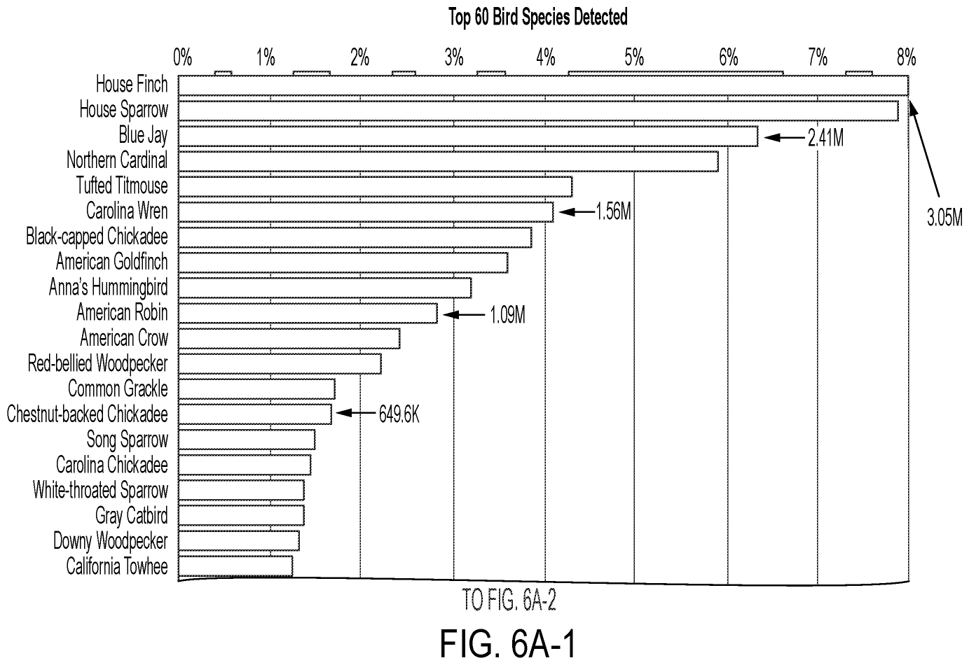

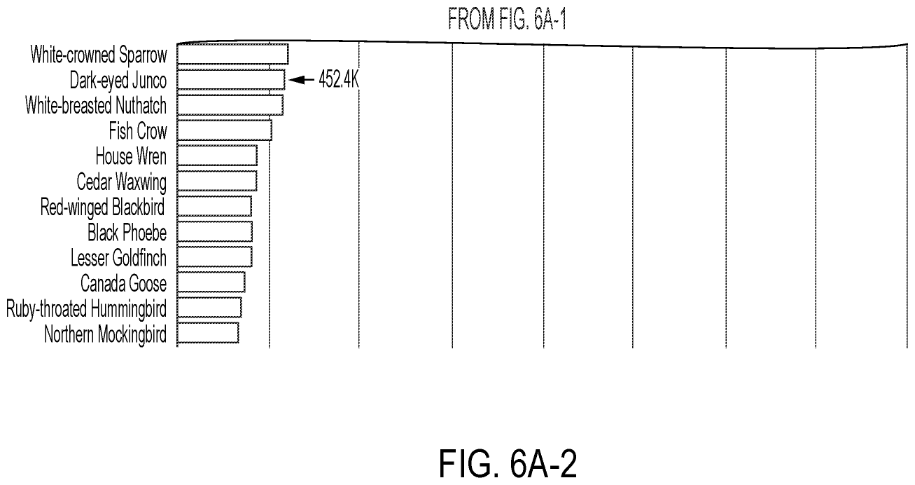

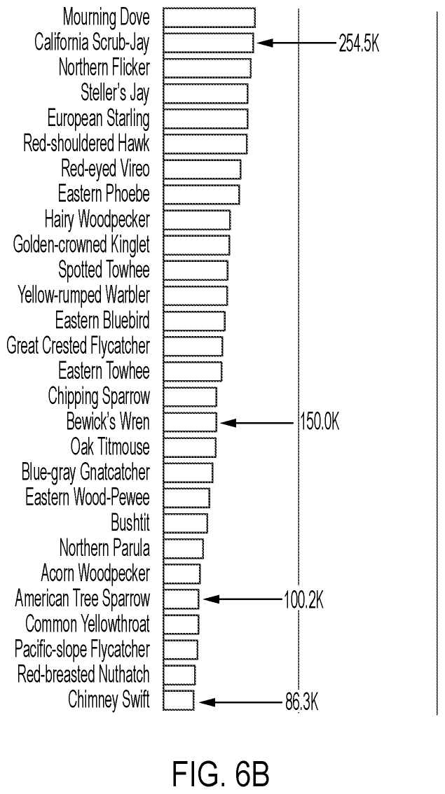

FIGS. 6A-1, 6A-2 and 6B are illustrations of a graph showing the top 60 bird species identified by the instant invention. These species cumulatively made up 90% of all detections. Each bar shows that species' percentage of the total number of detections. For example, the 86,275 Chimney Swift detections made up 0.2% of the 38 million total detections, putting it at number 60 on the list.

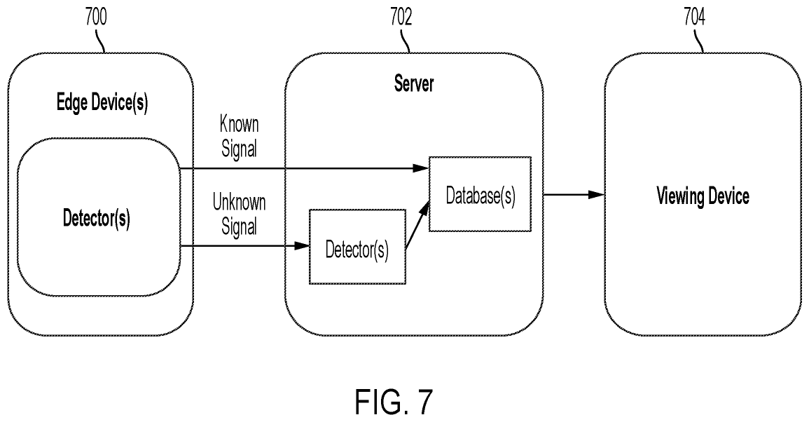

FIG. 7 is an illustration of a flow chart of the instant invention. This system uses a combination of edge devices or local server(s) as well as cloud neural networks to identify inputs (classes) of interest. At 700, inputs are first detected and run through one or more neural network algorithms by one or more edge device detectors. At 702, if the input identified by the edge device(s) is a known signal, the identification is stored directly to a database and skips the local/cloud-based detector(s). Unknown classes that are not able to be identified by the edge neural network will be sent to a separate local server or cloud-based neural networks for further processing before also being stored in the detection database. At 704, the viewing device, which may be any electronic device and/or a display including, but not limited to, a phone, a tablet, a computer, and/or another edge device may access a detection in the server database.

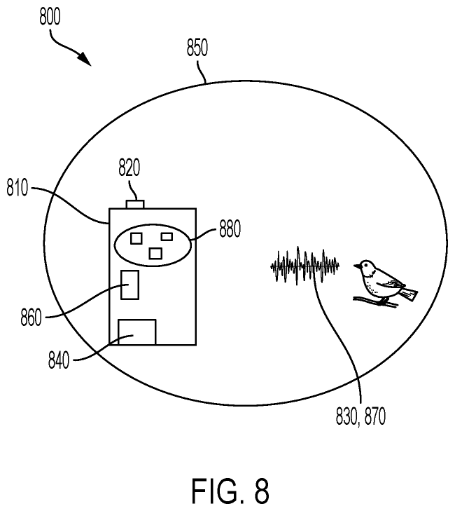

FIG. 8 is a diagram showing a preferred embodiment of the present hybrid neural network system 800 for detecting and classifying classes of birds. The system includes at least one edge device 810 which includes an audio sensor 820 for transducing sound 830 and a microcontroller for capturing an audio clip 840. The system includes a neural network 880 in communication with the edge device 810 and a set of instructions 860 on the edge device 810 for determining, initially, if the sound 830 is a bird sound 870 or if the captured sound is background (non-bird) sound. Furthermore, the set of instructions 860 on the edge device may also be used for determining the individual species of bird. The detection of the bird sound 870 triggers capturing of the audio clip 840 including the bird sound 870 which is stored to the either the edge device or cloud computing system. The stored bird sound and associated identification from either the edge neural network or the cloud neural network may be configured to display pictures and information about the species of bird detected on an end user device.

The edge neural network 880 may be trained on various signal data. The larger the training set of signal data, the more accurate the system will be at correctly identifying the signal source. Such a large training set, however, may make the system operate slower and may require more expensive components in every edge device, increasing costs overall. By utilizing the present hybrid neural network system, though, very common and computationally cheaper inferences may be made with an edge neural network while also alleviating traffic and congestion on the separate cloud neural network so it can focus on handling fewer, more complex inferences from many different users simultaneously.

In the present preferred embodiment, the edge neural network may be trained with a large data set of known bird sounds with associated labels describing the species associated with the bird sound. Moreover, it will be beneficial to also train the edge neural network on background (non-bird) sounds that are expected to be commonly encountered in the environment. Therefore, the edge neural network is able to make the vast majority of inferences required to identify the sounds without the need to communicate with the cloud neural network very often.

Similarly, the cloud neural network may be trained with an even larger set of known bird sounds with associated captions describing the species associated with the bird sound. Although the larger training set will require more computational cost, these adverse traits are minimized due to the low number of inferences, relatively, handled by the cloud neural network as opposed to the edge neural network.

The system 800 may include at least one additional edge device in communication with the neural network and for user interaction with the system. The edge device 810 may continually record all sounds in range of the audio sensor 850 for the audio clip to ensure inclusion of information in the seconds before the bird sound triggers the capturing of the audio clip, providing a full recording of the bird sound. The edge device may determine the length of the captured audio clip. The edge device may edit the captured audio clip for efficient allocation of computer memory and system bandwidth. The edge device may be a portable device. The neural network may obtain data clips from a hybrid cloud-based/local server. The audio sensor may be a microphone. Updates to the local server or cloud server may be performed remotely, and over-the-air updates can be sent to the connected edge device. The system may be a single edge device connected individually to an off-site server. Several local edge devices may be linked via a base-station or transmitting center.

In some embodiments the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, DVD or flash drive devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions.

The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing.

A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

The instant invention provides a solution which minimizes costs, allows a connected network of many edge devices, and works in low bandwidth situations. The invention is particularly applicable in situations where a few input classes make up a large proportion of the overall total of input classes to be detected and identified.

This is the situation for the detection and identification of natural sounds, including bird vocalizations, where a small number of common bird species make most of the sounds during any given day. For example, there are 1267 species of birds in the United States, but data collected during the development of this product showed that just 10 species produce half of all vocalizations and 60 species produce 90% of the vocalizations. A person in a typical backyard on a beautiful spring day will hear a soundscape dominated by a few species, with a song or call from a less common, but more interesting bird, very rarely. It is important to detect all of these classes, including the rare classes while minimizing costs by using economically priced but resource-limited devices.

The invention can be used for more than just bird sounds. These include, but are not limited to, any type of signal or sensory input such as images (e.g., pictures of plants, automobiles or animals), video (e.g., detected objects like people, cars, dogs, bicycles), vibrational or motion signals (e.g., accelerometer data streams from engines, oil/gas pipelines, geological sensors), sonar or acoustic signals (e.g., aeronautic or military equipment), weather and atmospheric input (e.g., rainfall, wind, dust, smoke, temperature, light levels, or fire), or chemical (e.g., crop health or nutrient levels). The initial classifier may be traditional signal processing (e.g., an energy detector or spectrogram correlator), a neural net, some combination of these or some other detection algorithm that can be run on the resource-constrained edge hardware.

The solution that minimizes overall costs in these situations is a system that effectively and efficiently splits species classification between the edge hardware that detects and identifies the most common species, and cloud servers which identify all species, including uncommon ones. In this solution, a small neural net capable ofrunning on low-cost edge computing hardware detects and identifies the most common class of interest (e.g., the 60 most common bird species which represent 90% of all detections) plus the general class of interest (e.g., all birds). Other sounds are identified on the edge as non-bird and not transmitted. Most signals will be detected and identified by the edge neural net, and thus will not need to be processed by the larger neural net in the cloud. The remaining small percentage of signals identified as ‘bird’ will be processed by the larger neural net running on a cloud server. This example would reduce the cloud server processing load and cost by 10×.

In one aspect of the invention, the system includes a convolutional neural net that runs on a resource-constrained edge microcontroller, such as the ESP-32-S3-WROOM-1 N16R8, for detecting bird and other sounds. The edge neural network is trained to recognize approximately 96 sound classes, including the species of birds most commonly detected using one embodiment of the instant invention. This includes birds like the Blue Jay, American Crow, and Tufted Titmouse. There are other classes which the neural network has been trained to detect including ‘bird’ as a general class designed to detect when any bird is calling, and classes of non-bird sounds that should be ignored, including environmental sounds (e.g., rain and wind), human-created sounds (e.g., speech and music), and other sounds (e.g., barking dogs, sirens, car horns).

The edge device is connected to a cloud computing system running on Amazon Web Services (AWS). The edge device has a microphone and continuously records sound from the environment and processes the audio using the edge neural network.

A new spectrogram is generated for each three second recorded clip which is then processed with the edge device's neural net to calculate a set of predictions that contain a score for each class that was used in the training set. The score for the ‘bird’ class is used to determine if any bird is present in the recording. If the score is high enough to indicate there is a bird present (for example score >0.90, or 90% confident, in the bird class), then the specific species with the highest score is analyzed. If this specific species score is above a set threshold (e.g., species score >0.80), then it is identified as that species. If there is no species score above the threshold of 0.80, but there is a bird present, the signal is sent to the local or cloud server for additional analysis with the larger neural network. The thresholds can be dynamic and also set remotely to control the amount of data being sent to the servers.

When there is a detection of a bird, the device looks up whether that species is in a list of the common species that the net accurately detects in that location.

If the bird is in the list of common species identified by the edge device's neural net (e.g., Blue Jay) the edge device compresses the audio and sends that detection directly to the Amazon server where the compressed audio is decompressed and stored as a flac file (S3 Audio Clip) in Amazon cloud storage (S3-1), and where it is also routed to a database table (Hit table). This eliminates the need to perform a time-consuming inference using the much larger (1,133 classes) cloud-based neural network which is too large to run on the edge device. Because local server and cloud computing is expensive this saves cost by using the less expensive edge hardware to detect common classes and not having to pay to perform the inference on a cloud server.

If the bird is not in the list of common species, then the audio clip is compressed and sent to the Amazon servers where it is decompressed and a cloud inference is performed with the large neural network. If the inference with the large neural network detects a bird, then that detection is routed to the same Hit Table and S3 audio clip storage system (S3-2) as detections that are sent directly by the edge device.

It may be easier to understand how this works using two vocalizing birds and one non-bird sound as examples. When a Northern Cardinal, a very common bird, begins singing, the edge device recognizes its song as one in its neural net. The identified three-second recording is compressed and sent to the server and then directly to the database table and is reported to a consumer using the smartphone app or website. When a Bald Eagle begins singing, the edge device recognizes it as a bird, but not one on which it was trained. Thus, it sends the compressed audio clip to the cloud for further analysis by the cloud server's neural net, which identifies it as a Bald Eagle, information which is then saved to the database and shared with the user via smartphone app and website. Should an ambulance siren be picked up by the edge device's microphone, the edge device's neural net would identify it as the class ‘siren’ on which it was trained. This sound will not be sent to the cloud, since no further processing or consumer notifications are needed.

One or more thresholds may be used on the edge system to determine the presence of signals of interest and how to report them to the cloud system. Not all signals of interest will be identified by the neural net with the same confidence, as would be expected when trying to identify natural sounds. Some sounds would be quite loud or made close to the device, while others could be far away or made in an otherwise noisy environment. The edge neural net will need to have thresholds above which it is confident enough to identify a particular bird. Using a single threshold for all classes would mean sounds of all Top-N species above that threshold would count as detections. However, each class may have a different threshold which would result in a more precise device capable of identifying both quiet inputs (e.g., hummingbirds) and loud inputs (e.g., crows) with similar accuracy.

As a resource-saving measure, it may be desirable to throttle the number of detections of common signals that are reported. In these cases, two thresholds may be used to handle these detections. For example, an edge system may report all detections classified of which it is extremely confident (e.g., greater than 90% confidence), but not to report detections or send detections to the cloud system for processing when the confidence is lower (e.g., between 20% to 90%). The use of two thresholds allows better fine-tuning by sending all detections which are most certainly correct and fewer detections which are very common but less certain. Multiple thresholds thus would allow reporting just a fraction of lower confidence signals. Instead, the system would report an overall count of these detections, rather than the detections themselves.

To estimate accuracy of the smaller edge neural net, a subset of the common species it detects may be sent to the cloud system for an additional identification, or “second opinion” of its original identification. The results of this comparison could be used to automatically adjust the detection thresholds and routing of signals to optimize accuracy and cloud computing costs.

This solution is hereby described in terms of using a neural net for classifying signals, but any signal processing algorithm(s) capable of detecting the most common signals on the edge device would also be included.

All detections are stored in a database on the server. The results of the predictions are provided to consumers/users on a website and smartphone app.

As noted previously, this invention can be used for more than just bird sounds. Similar applications include other acoustical sounds or noise, plus images and videos. These are the cases which could have very large numbers of input classes which might require substantial local server or cloud computing resources. There are nearly infinite types of sounds and images that might need to be detected, differentiated, identified, and reported on in an unlimited number of ways. Using the methodology outlined here would not only lead to extremely confident identifications, it would greatly reduce costs and provide a flexible system able to be easily updated and retrained with new information, while providing an assurance of privacy and security.

Other applications might include sensors designed to measure vibrational or motion signals which would require a neural net capable of identifying an established set of classes. These might include ‘normal’ vibrations from vehicles or wind which would be compared to those created by ruptured gas pipelines, or geothermal activity. Airports or the military might want to cheaply but quickly be alerted of ‘interesting’ acoustic or sonar activity that differs from ‘normal’ operations. Sensors for weather and atmospheric signals could be combined into sophisticated weather stations, while chemical monitoring might be useful for testing wastewater, looking for harmful or unusual trace elements in fertilizers or monitoring aquaculture facilities or home gardens.

The possible uses of this hybrid edge and local/cloud server computing system are only limited by the imagination, available training data and the sensors used to obtain it. This kind of system could be used to effectively reduce costs while improving results and providing a high degree of privacy and security.

This system could rely on any combination of one or more neural nets on edge detectors and/or devices with one or more cloud-based or local server neural networks. These devices and networks could work by communicating with each other, working in parallel, or by working in sequence, with one neural net passing information along to the next neural network. The specific application, method of development, or desired functionality will determine the specific configuration and function of each component. This allows for great flexibility in hardware selection and provides the ability to fine-tune functionality, while minimizing costs. A product might deploy one or more low-cost edge detectors/devices running a variety of specialized neural nets to maximize edge computing capabilities, while balancing this with cloud-based or local server neural nets which are more expensive to run but can be updated or changed quickly. All hardware and neural nets could be configured to communicate or work with detectors/devices created by other manufacturers or brands, or they could utilize a base station or central control hub, on the edge or in the cloud/local server, to coordinate, process or control the flow of data or inferences and their presentation to the customer/user. The number and way these edge devices, neural networks and cloud/server computing systems are configured and work together is only limited by the needs and creativity of the developer.

It is important to note that the neural nets used in this solution must be trained to detect and identify the particular signals of interest (classes). A neural net is an interconnected group of natural or artificial neurons that uses a mathematical or computational model for information processing based on a connectionist approach to computations.

Edge processors available today are physically much smaller than those created in even the recent past, and it is expected that they will continue to be smaller but more powerful in the future. This will allow the solution outlined here to include hardware of many shapes and designs. Form factors may include, but are not limited to, those which include a USB port or are shaped or function like a USB cable or device, a memory stick, or light bulb. They also may include or be integrated into solar-powered or cellphone/satellite enabled hardware or integrated into other Internet of Things (IoT) devices such as video doorbells or motion-triggered devices. These integrations or connections may include devices created by other companies or brands or those which are proprietary to the solution outlined here.

This kind of hybrid system also provides additional security that may be lacking in systems which rely heavily or exclusively on local server or cloud-based server systems. By locally identifying undesirable inputs, they are kept from being sent to an off-site database or storage location. This is particularly important when sensors or recording devices could accidentally record human speech or activities. An edge device that learns to identify and ignore these classes can provide peace-of-mind to consumers worried about nefarious listening or monitoring devices.

This system is also remarkably flexible, resilient, adaptable and easily updated. Updates to the local server(s) or cloud server(s) can be performed remotely, and over-the-air updates can be sent to the connected edge devices. The system can take the form of single edge devices connected individually to the off-site server(s) or several local edge devices can be linked together via a base-station or transmitting center. Many combinations of local edge devices talking to each other or sharing information identified by individual small neural nets can be envisioned, each playing a specifically defined role but communicating with others before transmitting information to the cloud or local server for consolidation, additional analysis or processing, and sharing with the end-user.

In the case of bird vocalizations, neural nets will be trained using thousands of recorded, labeled bird songs and calls, along with non-bird environmental sounds (e.g., wind and rain), human-created sounds (e.g., speech, music) and other sounds (e.g., barking dogs, car horns, engines). The neural nets process a spectrogram (a visual image of the sound with time on the x-axis and the sound frequency on the y-axis) which are used as a training set for the convolutional neural network. The spectrogram images are used to modify the weights of connections between the neurons in the neural network so it learns to be more accurate in identifying these known classes.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A hybrid edge and cloud system for detecting and identifying bird vocalizations, the hybrid edge and cloud system comprising:
an edge device including;
an edge neural network running on the edge device, the edge neural network trained with audio samples for making predictions about identification of the bird vocalizations, the edge neural network for generating a score based on the predictions; and
an audio sensor connected to the edge neural network, the audio sensor for sending sound information to the edge neural network;
a peripheral neural network implementing a cloud computing system that includes at least one cloud neural network for processing the sound information, the peripheral neural network including:
a first storage service and a second storage service in the peripheral neural network; and
a hit table which stores metadata about bird detections;
wherein the edge neural network generates a score for each of the trained audio samples based on predictions made from a bird audio clip and selects a top scoring audio sample; and
if the top scoring audio sample is not on a list of common bird species, the edge device sends the bird audio clip as a raw detection to the second storage service whereby the bird clip is processed for cloud inference and sent to the hit table; and
if the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table; and
a browsing device for browsing and listening, the browsing device having access to the peripheral network;
whereby the browsing device may request and receive video and audio information from the hit table regarding at least one of plurality of birds for which the hit table includes; and
whereby the browsing device may request and receive the video and the audio information after processing from the first storage service.

2. The system according to claim 1 wherein the edge device is a portable device.

3. A method for using a hybrid edge and cloud system for detecting and identifying bird vocalizations, the method comprising:
providing an edge device including an edge neural network running on the edge device, the edge neural network trained with audio samples for making predictions about identification of the bird vocalizations, the edge neural network for generating a score based on the predictions and an audio sensor connected to the edge neural network for sending sound information to the edge neural network;
providing access to a peripheral neural network with a cloud computing system that includes a cloud neural network for processing the sound information, the peripheral neural network including a first storage service and a second storage service in the peripheral neural network and a hit table which stores metadata about bird detections;
providing a browsing device for browsing and listening, the browsing device having access to the peripheral network;
the edge neural network generating a score for each of the trained audio samples based on predictions made from a bird audio clip and selecting a top scoring audio sample; and
if the top scoring audio sample is not on a list of common bird species, the edge device sends the bird audio clip as a raw detection to the second storage service whereby the bird clip is processed for cloud inference and sent to the hit table; and
if the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table; and
the browsing device requesting and receiving video and audio information from the hit table regarding at least one of plurality of birds for which the hit table includes; and
the browsing device requesting and receiving the video and the audio information after processing from the first storage service.

4. A hybrid edge and cloud system for detecting and identifying bird vocalizations, the hybrid edge and cloud system comprising:
an edge device including an audio sensor for audio input on an edge neural network trained with audio samples for making predictions about identification of the bird vocalizations; and
wherein the edge device communicates with a cloud neural network for processing the sound information, the cloud neural network including a hit table which stores metadata about bird detections;
wherein the edge neural network generates a score for each of the trained audio samples based on predictions made from a bird audio clip and selects a top scoring trained audio sample; and
if the scores indicate that no trained audio sample matches the bird audio clip, the bird audio clip is sent to the cloud neural network wherein the bird audio clip is processed for cloud inference and sent to the hit table.

5. The system according to claim 4 wherein if the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table.

6. The system according to claim 4 including a browsing device for browsing and listening, the browsing device having access to the cloud neural network wherein the browsing device may request and receive video and audio information from the hit table regarding at least one of plurality of birds for which the hit table includes and wherein the browsing device may request and receive the video and the audio information after processing from the first storage service.

7. The system according to claim 4 wherein the edge neural network generates a score based on the predictions, and a score is provided for each trained audio sample based on the predictions and the highest scoring trained audio sample is determined.

8. The system according to claim 4 wherein the first storage service is a first storage service and the second storage service is a second storage service in the cloud neural network.

9. The system according to claim 4 wherein the edge neural network generates a score for each of the trained audio samples based on predictions made from the bird audio clip and selects a top scoring audio sample and if the top scoring audio sample is not on a list of common bird species, the edge device sends the bird audio clip as a raw detection to the second storage service whereby the bird clip is processed for cloud inference and sent to the hit table.

10. The system according to claim 4 wherein the edge neural network generates a score for each of the trained audio samples based on predictions made from the bird audio clip and selects a top scoring audio sample and if the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table.

11. A hybrid edge and cloud system for detecting and identifying a sound, the hybrid edge and cloud system comprising:
an edge device including;
an edge neural network running on the edge device, the edge neural network trained with audio samples for making predictions about identification of the sound, the edge neural network for generating a score based on the predictions; and
an audio sensor connected to the edge neural network, the audio sensor for sending sound information to the edge neural network;
a cloud computing system that includes a cloud neural network for processing the sound information, the cloud computing system including:
a first storage service and a second storage service; and
a hit table which stores metadata about sound detections;
wherein the edge neural network generates a score for each of the trained audio samples based on predictions made from a sound audio clip and selects a top scoring audio sample; and
if the top scoring audio sample is not on a list of common sound, the edge device sends the sound audio clip as a raw detection to the second storage service whereby the sound clip is processed for cloud inference and sent to the hit table; and
if the top scoring audio sample is on a list of common sounds, the edge device determines that if the sound clip is not a published sound clip, the sound clip is sent to the hit table and if the sound clip is a published sound clip, the sound clip is sent to the first storage service wherein the sound clip is processed for entry into the hit table; and
a browsing device for browsing and listening, the browsing device having access to the cloud computing system;
whereby the browsing device may request and receive video and audio information from the hit table regarding at least one of plurality of sounds for which the hit table includes; and
whereby the browsing device may request and receive the video and the audio information after processing from the first storage service.

12. A method for using a hybrid edge and cloud system according to claim 11, the method comprising:
the edge neural network generating a score for each of the trained audio samples based on predictions made from a bird audio clip and selecting a top scoring audio sample; and
if the top scoring audio sample is not on a list of common bird species, the edge device sends the bird audio clip as a raw detection to the second storage service whereby the bird clip is processed for cloud inference and sent to the hit table; and
if the top scoring audio sample is on a list of common bird species, the edge device determines that if the bird clip is not a published bird clip, the bird clip is sent to the hit table and if the bird clip is a published bird clip, the bird clip is sent to the first storage service wherein the bird clip is processed for entry into the hit table; and
the browsing device requesting and receiving video and audio information from the hit table regarding at least one of plurality of birds for which the hit table includes; and
the browsing device requesting and receiving the video and the audio information after processing from the first storage service.
